(19) United States
(12) Patent Application Publication
(10) Pub. No.: US 2026/0310902 A1
(43) Pub. Date: Oct. 8, 2026

(54) EFFICIENT AUTOMATED DATA EXTRACTION BY MACHINE LEARNING ROUTING

(71) Applicant: Intuit Inc., Mountain View, CA (US)

(72) Inventors: Shon MENDELSON, Tel Aviv (IL); Justin Rui Chang CHIANG, San Diego, CA (US); Yiran HUANG, San Diego, CA (US)

(73) Assignee: Intuit Inc., Mountain View, CA (US)

(21) Appl. No.: 19/098,777

(22) Filed: Apr. 2, 2025

(51) Int. Cl. G06F 40/40

(52) U.S. Cl. CPC G06F 40/40

(57) ABSTRACT

A method including receiving a document, including content data, for document extraction of the content data. A metadata data structure, storing metadata for the document, is generated. The method also includes executing a routing model on the metadata data structure to generate a complexity prediction and a corresponding confidence score for the complexity prediction. The complexity prediction includes an indication of an extraction complexity of performing the document extraction. The method also includes determining, based on a combination of the complexity prediction and the corresponding confidence score, a routing decision to route the document to one of a first extraction model including a low computational cost and a second extraction model including a high computational cost relative to the low computational cost. The method also includes routing, according to the routing decision, the document to a selected model including the first extraction model or the second extraction model.

### BACKGROUND

Large language models are neural network machine learning models having billions of parameters or more. Large language models are trained to process natural language queries and generate natural language outputs.

One use of a large language model is to extract data from a document. For example, a large language model may be instructed to extract data from a portable document (PDF) file, a Word file, or some other text-based document. A multimodal large language model (a model that can also process images) also may extract data from an image (e.g., a digitized photograph or other image). Thus, a large language model may be commanded to extract categories and data entries for those categories from a data structure defining a file. As a specific example, a large language model may, extract from a digital W-2 tax form the data entry of “$40,000” for the category “taxable income.”

However, a technical problem arises when using large language models to extract data from various data structure files. A large language model, having billions of parameters, is computationally complex and therefore computationally expensive. As a result, the extraction process may have high latency (i.e., take too long relative to a desired processing time). Furthermore, physical processing resources may be limited. Thus, using a large language model to extract data from a particular set of data structure files may be impractical, impossible, or otherwise undesirably expensive. However, other data extraction programs may lack the ability of language models to match data entries to data categories, leading to errors in data extraction. Thus, for some automated data extraction projects, there is no adequate solution to the technical problem of correctly and accurately extracting data within available physical processing resources.

### SUMMARY

One or more embodiments provide for a method. The method includes receiving a document, including content data, for document extraction of the content data. The method also includes generating a metadata data structure storing metadata for the document. The method also includes executing a routing model on the metadata data structure to generate a complexity prediction and a corresponding confidence score for the complexity prediction. The complexity prediction includes an indication of an extraction complexity of performing the document extraction. The method also includes determining, based on a combination of the complexity prediction and the corresponding confidence score, a routing decision to route the document to one of a first extraction model including a low computational cost and a second extraction model including a high computational cost relative to the low computational cost. The method also includes routing, according to the routing decision, the document to a selected model including the first extraction model or the second extraction model.

One or more embodiments also provide for a system. The system includes a computer processor and a data repository in communication with the computer processor. The data repository stores a document including content data. The data repository also stores a metadata data structure storing metadata for the document. The data repository also stores a complexity prediction including an indication of an extraction complexity of performing a document extraction on the document. The data repository also stores a confidence score corresponding to the complexity prediction. The data repository also stores a routing decision. The system also includes a first extraction model in communication with the computer processor and including a low computational cost. The system also includes a second extraction model in communication with the computer processor and including a high computational cost relative to the low computational cost. The system also includes a routing model which, when executed by the computer processor on the metadata data structure generates the complexity prediction and the confidence score. The system also includes a server controller which, when executed by the computer processor receives the document. The server controller also, when executed by the computer processor, generates the metadata data structure. The server controller also, when executed by the computer processor, executes the routing model. The server controller also, when executed by the computer processor, determines, based on a combination of the complexity prediction and the confidence score, the routing decision to route the document to one of the first extraction model and the second extraction model. The server controller also, when executed by the computer processor, routes, according to the routing decision, the document to a selected model including the first extraction model or the second extraction model.

One or more embodiments provide for another method. The method includes receiving a document, including content data, for document extraction of the content data. The method also includes generating a metadata data structure storing metadata for the document. The method also includes executing a routing model on the metadata data structure to generate a complexity prediction and a corresponding confidence score for the complexity prediction. The complexity prediction includes an indication of an extraction complexity of performing the document extraction. The method also includes determining that the confidence score falls between a first threshold and a second threshold less than the first threshold. The method also includes executing, responsive to determining the confidence score falls between the first threshold and the second threshold, a complex routing model on both the metadata data structure and at least some content of the document. The complex routing model includes a second computational cost higher than a first computational cost of the routing model. Executing the complex routing model generates a routing decision between a first extraction model including a low computational cost and a second extraction model including a high computational cost relative to the low computational cost. The method also includes routing, according to the routing decision, the document to a selected model including the first extraction model or the second extraction model.

Other aspects of one or more embodiments will be apparent from the following description and the appended claims.

### BRIEF DESCRIPTION OF DRAWINGS

FIG. 1 shows a computing system, in accordance with one or more embodiments.

FIG. 2 shows a flowchart of a method for efficient automated data extraction by machine learning routing, in accordance with one or more embodiments.

FIG. 3A and FIG. 3B show an example of efficient automated data extraction by machine learning routing, in accordance with one or more embodiments.

FIG. 4A and FIG. 4B show a computing system and network environment, in accordance with one or more embodiments.

Like elements in the various figures are denoted by like reference numerals for consistency.

### DETAILED DESCRIPTION

One or more embodiments are directed to efficient automated data extraction by machine learning routing. In particular, one or more embodiments represent a technical solution to the technical problem of correctly and accurately extracting data within available physical processing resources.

Briefly, the technical solution involves generating metadata regarding a document from which data is to be extracted. The metadata is then input to a trained routing model. The routing model is trained to predict, from the input metadata, whether the document should be routed to one of two or more extraction programs. If the document represents a complex extraction problem, then the document is routed to a large language model. If the document represents a relatively simple or easy extraction problem, then the document is routed to a less computationally complex data extraction program (e.g., a smaller language model, an optical character recognition (OCR) program, etc.).

In somewhat more detail, the metadata is generated based on predetermined metadata types that are computationally fast and efficient to determine for a given document (relative to the computational resources needed to extract the data from the document). The metadata may include information, such as the types of the documents, the lengths of the documents (e.g., number of pages), the number of characters in each of the documents, the presence or absence of tabular features in the documents (e.g., whether the documents contain tables), and possibly other forms of metadata. The metadata is stored in the form of a vector data structure, which is a type of data structure which certain classification machine learning models may accept as input.

The vector data structure storing the metadata is input to a first routing model, trained as described below. The output of the routing model is a classification that is assigned to the document, together with a confidence score. The classification indicates the type of program (e.g., simple verses complex) that should perform the data extraction task on the document. The confidence score represents a probability estimated by the classification model that the classification is correct.

If the confidence score is high (i.e., satisfies a predetermined threshold), then the document is routed to the predicted type of data extraction program. If the confidence score is low (i.e., fails to satisfy the predetermined threshold) then the metadata data structure and additional information regarding the document is provided as input to a second routing model that is more complex and more computationally intensive than the first routing model. The output of the second routing model also classifies the document in terms of which extraction program should perform data extraction on the document.

Data extraction is then performed using the extraction program, as determined by either the first routing model or the second routing model. The extracted data is stored for further use.

One or more embodiments are computationally efficient. In particular, documents that should be processed by computationally complex data extraction programs may be processed by a large language model or other computationally complex data extraction programs. However, documents, possibly many documents in a document set, that may be accurately processed by a computationally efficient program (e.g., an OCR program) are routed accordingly. Thus, using one or more embodiments, automated data extraction may be performed on large numbers of data files with limited computational resources.

One or more embodiments stand in contrast to known model routing techniques. For example, a single model (selected from among several different model types) has been used to predict whether an input should be routed to a lean model (i.e., computationally efficient model) or a full large language model (i.e., a complex model). See Ong, et al., “RouteLLM: Learning to Route LLMs with Preference Data,” arXiv: 24061.18665v 3 [cs.LG], 21 Jul. 2024. The preference data in Ong, et al., refers to recorded preference decisions of users when a prompt is provided as input to the two different models (i.e., efficient versus complex). Id., section 3.1. That data is used to train the routing model (see section 4) that routes new data extraction requests (see sections 3.1.1 and 3.2). While several different routing models are developed from different base machine learning models, in each case one selected routing model performs the routing decision. Id., sections 2 and 4.In each case, the input to the routing model is the new query. Id., sections 3 and 4.

One or more embodiments include several differences and improvements over Ong, et al. and any other known art. For example, one or more embodiments use metadata regarding a document (i.e., the document to be extracted) as the input to the routing model, rather than the document itself or rather than using a query to perform the data extraction. Metadata may be generated or extracted much more quickly than extracting the data in the document itself. Thus, by using metadata as the input to the routing model, a substantial increase in computational efficiency is achieved.

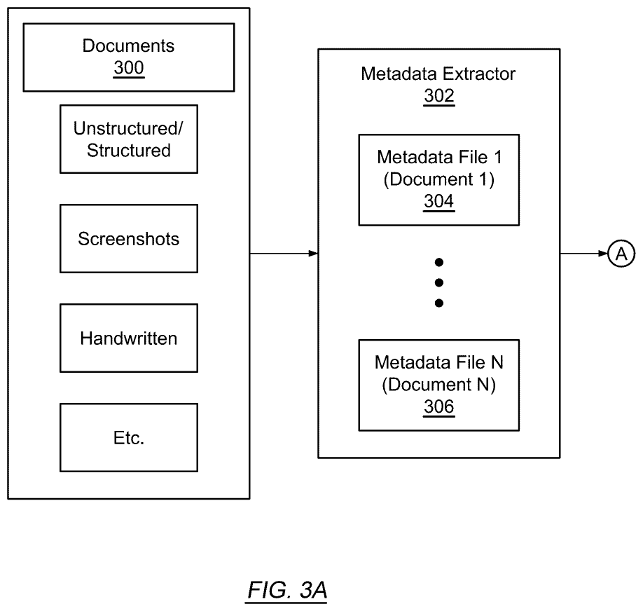

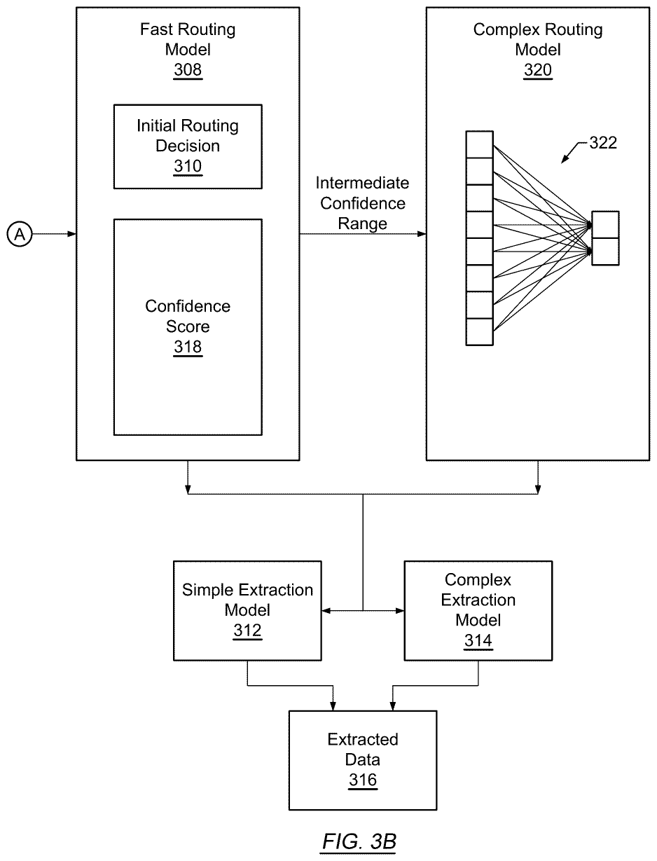

One or more embodiments also provide for an architecture in which a second, more complex routing model is used if the predicted confidence score of a first routing model (that is more computationally efficient than the complex routing model) fails to satisfy a confidence threshold or if the predicted confidence score is in an intermediate range between upper and lower confidence thresholds. (See, for example, FIG. 3A and FIG. 3B, below). The efficient routing model takes metadata as input, as above. However, if the output of the efficient routing model is insufficiently confident, then the more complex routing model takes, as input, not only the metadata but also structural data contained in the document to be extracted (e.g., tabular features in the document). While the more complex routing model uses more processor resources than the first, simpler routing model, the more complex routing model is still far less computationally intensive than a full large language model when performing data extraction. Thus, computational efficiency is still increased, yet the accuracy of the ultimate data extraction task will remain high because the routing decision (between the simple and complex extraction models) will be more accurate compared to using the efficient routing model alone.

Thus, one or more embodiments represent a substantial improvement over the known art, such as Ong, et al. In brief, first, metadata is used as input, rather than a query submitted or the document itself, thereby achieving greater computational efficiency. Second, if greater accuracy of routing is desired, then a bilevel routing embodiment provides for both an efficient routing model and a complex routing model that, together, accurately route the document to the efficient extraction model or the complex extraction model. Again, as an example, reference is made to FIG. 3A and FIG. 3B, below.

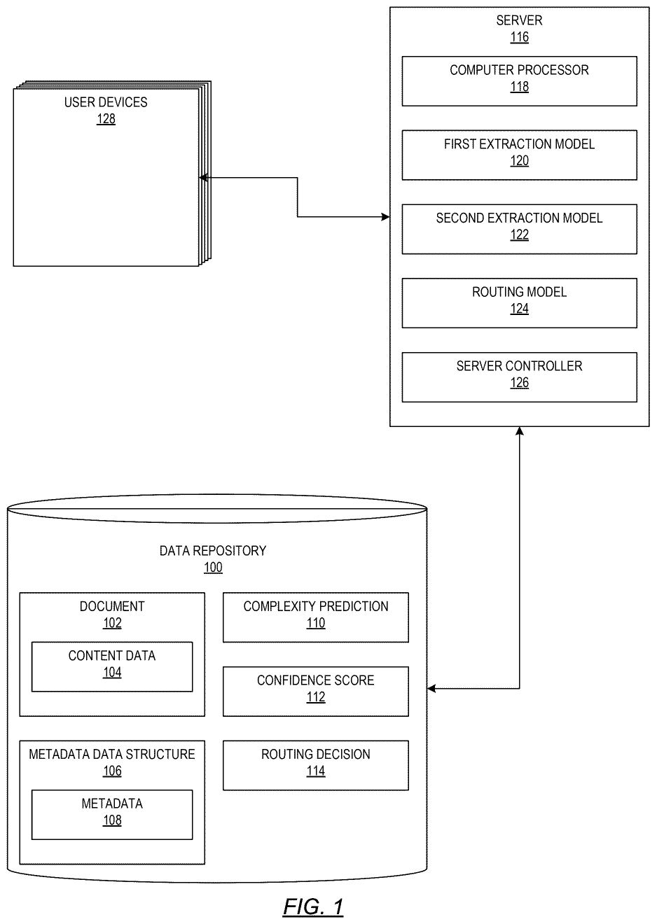

Attention is now turned to the figures. FIG. 1 shows a computing system, in accordance with one or more embodiments. The system shown in FIG. 1 includes a data repository (100). The data repository (100) is a type of storage unit or device (e.g., a file system, database, data structure, or any other storage mechanism) for storing data. The data repository (100) may include multiple different, potentially heterogeneous, storage units and/or devices.

The data repository (100) stores a document (102). The document (102) is a computer readable data structure storing content data (104) (defined below). Examples of the document (102) include digitized images, text files, portable document file (PDF) data structures, and many other data structures.

The data repository (100) also stores content data (104). The content data (104) is the information of interest. While the content data (104) is often text data including alphanumeric text, as well as the relationships among such alphanumeric text, the content data (104) also may include images in the case that one or more images are the content of interest.

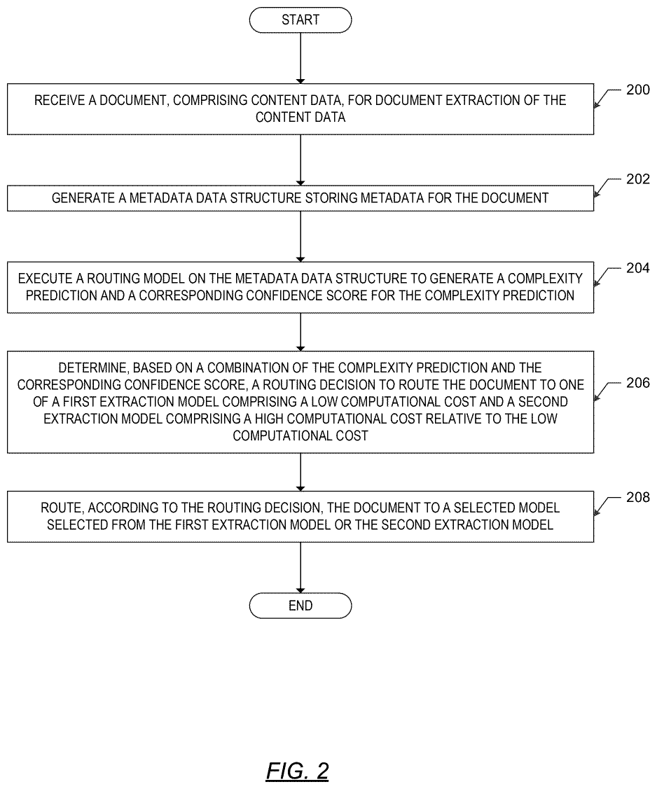

The content data (104) does not begin the method of FIG. 2 in a computer readable format. For example, the content data (104) may be a digitized image file or a PDF file that has not had optical character recognition (OCR) performed on it. As a result, the text or other content contained in the image file or PDF file may not be in a computer readable format. However, the text or other content contained in the document (102) may be converted automatically into the computer readable format.

The data repository (100) also stores a metadata data structure (106). The metadata data structure (106) is a data structure configured to store metadata (108) (defined below) in a computer readable format. Examples of the metadata data structure (106) may include a relational database, a graph database, an object notation language data structure, a key-value pair structure, a matrix data structure, the file extension of the document (102), a classification (e.g., by a classification model) of the document, a label assigned to the document, etc.

The data repository (100) also stores metadata (108). The metadata (108) is information about the document (102) or may be a portion of the content data (104) in some cases, but the metadata (108) is less than the full content data (104). The metadata (108) may be generated for the document (102) quickly and easily, relative to the process of extracting the content data (104) from the document (102). Examples of the metadata (108) include a type of the document (102), document length, a number of characters in a document, the presence or absence of tabular features in the document (102) (e.g., tables), etc.

Generation of the metadata (108) is described with respect to FIG. 2, step 202. Use of the metadata (108) is described with respect to FIG. 2, step 204.

Note that the number of characters may be possible to extract quickly, but the content data (104) may remain difficult to extract. The reason is that often relationships between the characters may be difficult to extract, and those relationships may be of interest for a given data extraction task. Thus, simply converting the document (102) into alphanumeric text may be inadequate for the document extraction process but may be information of interest for use as one element (possibly among many) of the metadata (108).

The data repository (100) also stores a complexity prediction (110). Briefly, the complexity prediction (110) is an indication of the extraction complexity of performing the document extraction using an extraction model, such as the first extraction model (120) or the second extraction model (122) defined below.

The complexity prediction (110) is the output of the routing model (124), defined below. The complexity prediction (110) takes the form of a number, typically between 0.0 and 1.0, which indicates a quantitative assessment of the complexity of the computing task of extracting the content data (104) from the document (102). The closer the complexity prediction (110) is to the number “1,” the more complex the computing task and the more processing resources that are predicted to be used to perform the data extraction. The closer the complexity prediction (110) is to the number “0,” the simpler the computing task and the fewer processing resources that are predicted to be used to perform the data extraction. However, the complexity prediction (110) may take other formats (i.e., different numbers, classification categories, etc.)

Note that in some embodiments (e.g., the example in FIG. 3A and FIG. 3B) there may be two or more instances of the complexity prediction (110). For example, there may be multiple instances of the routing model (124), as defined below and as shown by way of example in FIG. 3A and FIG. 3B.

The data repository (100) also stores a confidence score (112). The routing model (124) also outputs the confidence score (112). The confidence score (112) is a number representing the predicted likelihood that the complexity prediction (110) is a correct prediction of the complexity of extracting the content data (104) from the document (102). Again, the confidence score (112) is a typically a number between “0” and “1,” with “0” representing no confidence in the complexity prediction (110) and a “1” indicating the highest confidence in the complexity prediction (110). Like the complexity prediction (110), the confidence score (112) may take other formats (i.e., different numbers, classification categories, etc.)

The data repository (100) also stores a routing decision (114). The routing decision (114) is a command by either the routing model (124) or the server controller (126) (typically the server controller (126)) that the process of extracting the content data (104) from the document (102) will be performed by, one of a first extraction model (120) or a second extraction model (122) (or perhaps by some other extraction model). For example, the routing decision (114) may be a command from the server controller (126) that the first extraction model (120) should extract the content data (104) from the document (102). In another example, the routing decision (114) may be a command from the server controller (126) that the second extraction model (122) should extract the content data (104) from the document (102). Generation of the routing decision (114) is described in step 206 of FIG. 2 and use of the routing decision (114) is described in step 208 of FIG. 2.

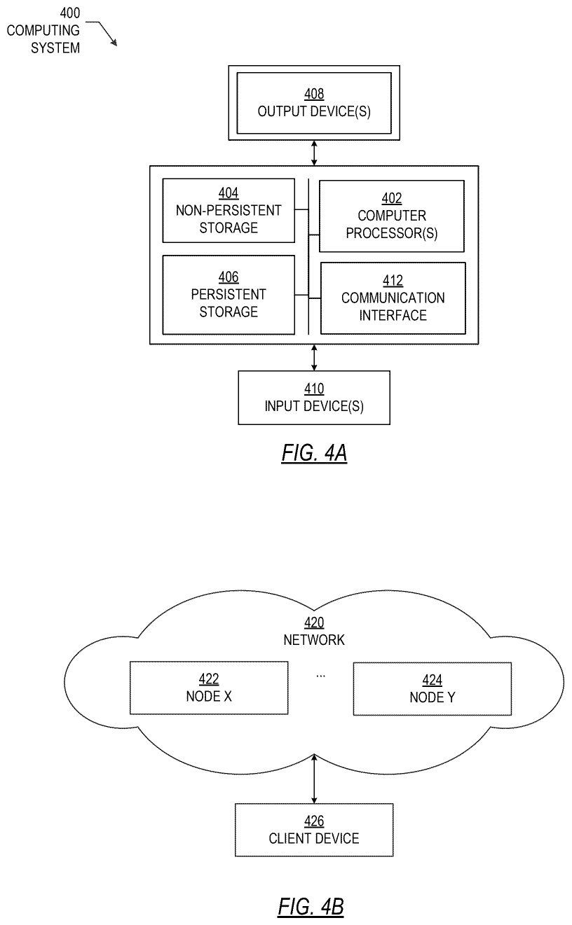

The system shown in FIG. 1 may include other components. For example, the system shown in FIG. 1 also may include a server (116). The server (116) is one or more computer processors, data repositories, communication devices, and supporting hardware and software. The server (116) may be in a distributed computing environment. The server (116) is configured to execute one or more applications, such as the first extraction model (120), the second extraction model (122), the routing model (124), and the server controller (126). An example of a computer system and network that may form the server (116) is described with respect to FIG. 4A and FIG. 4B.

The server (116) includes a computer processor (118). The computer processor (118) is one or more hardware or virtual processors which may execute computer readable program code that defines one or more applications, such as the first extraction model (120), the second extraction model (122), the routing model (124), and the server controller (126). An example of the computer processor (118) is described with respect to the computer processor(s) (402) of FIG. 4A.

The server (116) also includes at least a first extraction model (120) and a second extraction model (122). Both the first extraction model (120) and the second extraction model (122) are programmed to extract the content data (104) from the document (102). However, the difference between the first extraction model (120) and the second extraction model (122) is that one of the two models uses more computational resources than the other model and may be more accurate than the other model with respect to certain document types.

Thus, the first extraction model (120) and the second extraction model (122) may be selected from among a variety of different models. The first extraction model (120) and the second extraction model (122) may be a large language model (such as but not limited to the Llama-3.2-90B-Vision-Instruct model), a small language model (i.e., a language model having fewer parameters than a large language model, such as but not limited to the Llama-3.2-11B-Vision-Instruct model), a multimodal model (i.e., a model that processes both language and images together), an optical character recognition (OCR) model, or other data extraction models.

In general, a language model is a natural language processing machine learning model, typically structured as a neural network having attention heads. An example of a language model may be a large language model, such as CHATGPT® by OPENAI, LLC, or the Llama models mentioned above. However, different language models may be used.

The server (116) also includes a routing model (124). The routing model (124) is a classification model or a small language model. The type of model used for the routing model (124) may depend on the document type of the document (102). For example, if the document (102) is a relational database or otherwise contains tabular features (e.g., tables), then the routing model (124) may be an XGBoost classification machine learning model. However, the routing model (124) may be a multimodal classification model, such as a document image transformer (DiT) or a BERT pre-training of image transformers (BEiT) model.

The routing model (124) may include a combination of multiple routing models. For example, as shown in FIG. 3A and FIG. 3B, for greater efficiency, a lightweight model (i.e., a model that is less computationally expensive than a larger model) may perform an initial routing decision, as explained in FIG. 3A and FIG. 3B. If the confidence score is too low, then a larger model (e.g., a neural network) may be a second routing model that performs the actual routing decision (again, see FIG. 3A and FIG. 3B).

The server (116) also includes a server controller (126). The server controller (126) is software or application specific hardware, which when executed by the computer processor (118), controls and coordinates operation of the software or application specific hardware described herein. Thus, the server controller (126) may control and coordinate execution of the first extraction model (120), the second extraction model (122), the routing model (124), and the server controller (126). The server (116) may execute the method of FIG. 2 or the example method of FIG. 3A and FIG. 3B.

The system shown in FIG. 1 also may include one or more user devices (128). The user devices (128) are computing systems (e.g., the computing system (400) shown in FIG. 4A) that communicate with the server (116).

The user devices (128) may be considered remote or local. A remote user device is a device operated by a third-party (e.g., an end user of a chatbot) that does not control or operate the system of FIG. 1. Similarly, the organization that controls the other elements of the system of FIG. 1 may not control or operate the remote user device. Thus, a remote user device may not be considered part of the system of FIG. 1.

In contrast, a local user device is a device operated under the control of the organization that controls the other components of the system of FIG. 1. Thus, a local user device may be considered part of the system of FIG. 1.

While FIG. 1 shows a configuration of components, other configurations may be used without departing from the scope of one or more embodiments. For example, various components may be combined to create a single component. As another example, the functionality performed by a single component may be performed by two or more components.

FIG. 2 shows a flowchart of a method for efficient automated data extraction by machine learning routing, in accordance with one or more embodiments. The method of FIG. 2 may be implemented using the system of FIG. 1 and one or more of the steps may be performed on or received at one or more computer processors.

Step 200 includes receiving a document, including content data, for document extraction of the content data. The document may be received from a user device or from another application service that calls the server controller executing the method of FIG. 2. The document may be retrieved by the server controller from a data repository. The document may be received by other data transfer methods.

Step 202 includes generating a metadata data structure storing metadata for the document. Generating the metadata data structure includes establishing a computer readable data structure configured to store the metadata of interest. Thus, the process of generating the metadata data structure and the metadata may differ, depending on the nature of the metadata of interest with respect to the documents upon which data extraction is to be performed.

Generation of the metadata is performed based on the type of metadata. As defined above with respect to the metadata (108) of FIG. 1, the data metadata may be various different properties of a document that are computationally efficient to determine (e.g., document type, document length, number of characters, etc.). Generation of the metadata may depend on the type of metadata. For example, a relatively simple program can identify the document extension of the document file name, compare the document extension to a library of file extensions, and thereby identify the document type of the document. Another program may quickly assess the page length of the document. An optical character recognition program may identify the number of characters in the document. Other programs may be used to generate other types of metadata.

Generation of the metadata data structure is performed in a manner to store the metadata of interest. In many cases, the generating of the metadata data structure includes generating a vector data structure, where each document is assigned a number of features and a number of feature values. The features represent the metadata types. Thus, for example, the features may be document type, document length, etc. The feature values are the numbers that reflect the quantitative assessment of the corresponding feature. For example, if the feature is “document type,” then the number “1” may be assigned to PDF files (i.e., if the feature value for a given document for the “document type” feature is “1,” then the routing model (at step 204) will understand that the document type is a PDF file.

As an example, generating the metadata data structure at step 202 may include determining a type of the document. Then, step 202 includes assigning a metadata value to the type of the document. Then, step 202 includes storing the metadata value in the metadata data structure. In the example, the document includes two metadata features that represent the type of the document: file extension and classification. In the example, the feature values are “PDF” and “W-2 tax form.”

In another example, generating the metadata data structure at step 202 includes determining the structure of the document. Then, step 202 includes assigning a metadata value to the structure of the document. Then, step 202 includes storing the metadata value as the metadata. In the example, the structure of the document includes at least one of a tabular structure, a table structure, and a text structure. In the example, the document includes a tabular structure.

Step 204 includes executing a routing model on the metadata data structure to generate a complexity prediction and a corresponding confidence score for the complexity prediction. As indicated above, the complexity prediction is an indication of an extraction complexity of performing the document extraction using an extraction model.

The routing model may be a single model (as defined with respect to the routing model (124) in FIG. 1). The routing model may include multiple routing models (as described in FIG. 1 and exemplified in FIG. 3A and FIG. 3B). In any case, the routing model takes the metadata data structure as input and generates a routing decision as output. When multiple routing models are being used (e.g., FIG. 3A and FIG. 3B), then the first routing model also may output a confidence score. When the confidence score is below a predetermined threshold, then the more computationally expensive routing model may take the metadata data structure as input and generate the final routing decision as output.

Step 206 includes determining, based on the combination of the complexity prediction and the corresponding confidence score, a routing decision to route the document to one of a first extraction model having a low computational cost and a second extraction model having a high computational cost relative to the low computational cost. Determining the routing decision may be performed by a server controller. The server controller may compare the complexity prediction to a predetermined prediction threshold and the confidence score to a predetermined confidence threshold. If the confidence score satisfies the confidence threshold, then the routing decision of a first routing model is used to route the document. If the confidence score does not satisfy the confidence threshold, or if the complexity prediction fails to satisfy the prediction threshold, then the routing decision of a second routing model (more computationally expensive to execute than the first routing model) is used to route the document.

In another embodiment, a single routing model is used. In this case, the confidence score may be disregarded. Alternatively, failure to satisfy the confidence score may cause the routing decision to be to route the document to a more computationally complex extraction model. Otherwise, the routing decision output by the routing model is used as the routing decision (i.e., to route the document to a more computationally complex extraction model or less computationally complex extraction model).

Step 208 includes routing, according to the routing decision, the document to a selected model selected from the first extraction model or the second extraction model. Routing may be performed by commanding the selected extraction model to extract the content data from the document. Routing also may include electronically transmitting the document to a server that hosts the extraction model. Routing by command or by transmitting the document may be performed by a server controller.

Thus, for example, assume the extraction complexity indicates a low complexity and the corresponding confidence score exceeding a first threshold. In this case, the server controller routes the document to a first extraction model that is less computationally expensive than a second extraction model.

In another example, assume the extraction complexity indicates a high complexity and the corresponding confidence score exceeding a first threshold. In this case, the server controller routes the document to the second extraction model.

In still another example, assume the corresponding confidence score fails to satisfy a second threshold lower than a first threshold. In this case, the server controller routes the document to the second extraction model without regard to the complexity prediction.

In yet another example, routing also may be based on the type of the document. For example, if the document includes tabular data (e.g., tables, relational databases, etc.) then routing may include routing the document to a tree-based machine learning model. Tree-based machine learning models may be computationally more efficient at processing tabular data.

The method of FIG. 2 may be varied. The method of FIG. 2 may include more or fewer steps. The steps described above may be varied as well.

For example, the method of FIG. 2 may further include extracting, by the selected model, content data from the document. The content data may be returned. Returning the content data may include storing the content data in a data repository, such as a non-transitory computer readable storage medium or other memory, transmitting the content data to another computer, passing the content data to another executable program, presenting the content data to a user on a graphical user interface, etc.

In another variation, a determination is made that the corresponding confidence score falls between a first threshold and a second threshold less than a first threshold. In this case, the method includes executing, responsive to determining the corresponding confidence score falls between the first threshold and the second threshold, a complex routing model on both the metadata data structure and at least some content of the document. The complex routing model may be the routing model that is computationally more expensive than the initial routing model that is used. In other words, the complex routing model includes a second computational cost higher than a first computational cost of the routing model. The method then includes executing the complex routing model to generate a second routing decision between the first extraction model and the second extraction model. In this case, determining the routing decision includes routing the document to one of the first extraction model and the second extraction model according to the second routing decision.

In a variation of the method of FIG. 2, a related method may be performed. For example, one or more embodiments contemplate receiving a document, including content data, for document extraction of the content data. A metadata data structure storing metadata is generated for the document.

A routing model is executed on the metadata data structure to generate a complexity prediction and a corresponding confidence score for the complexity prediction. The complexity prediction includes an indication of an extraction complexity of performing the document extraction.

A determination is made that the confidence score falls between a first threshold and a second threshold less than the first threshold. The method then includes executing, responsive to determining the confidence score falls between the first threshold and the second threshold, a complex routing model on both the metadata data structure and at least some content of the document. The complex routing model includes a second computational cost higher than a first computational cost of the routing model.

The method then executing the complex routing model generates a routing decision between a first extraction model including a low computational cost and a second extraction model including a high computational cost relative to the low computational cost. The method then includes routing, according to the routing decision, the document to a selected model including the first extraction model or the second extraction model.

Next, the method may include extracting, by the selected model, content data from the document. The method then may include returning the content data.

While the various steps in the flowchart of FIG. 2 are presented and described sequentially, at least some of the steps may be executed in different orders, may be combined or omitted, and at least some of the steps may be executed in parallel. Furthermore, the steps may be performed actively or passively.

The method also may include obtaining data for training the routing model. The method also may include performing the training of the routing model.

Obtaining labeled data for routing tasks can be resource intensive. Therefore, a semi-automatic approach may be performed to obtain labeled data for training. Initially, factors are assigned for each document. Each entity in the training/validation set may be processed using a text extraction algorithm to extract elements, such as line items and summary fields (e.g., customer name, vendor name, subtotal, total, etc.) from known documents.

If the text extraction program accurately identifies the elements, the document is more likely to contain structured data. The presence of line items and at least either a vendor name or a total amount in the summary fields of the extracted data also indicate a type of document (e.g., an invoice). To enhance accuracy, a pre-trained multi-class classifier, “dit-large-finetuned-rvlcdip” may be used to filter documents. The documents may focus on budgets and invoices since these types are more likely to be inherently structured.

The next training data generation step is to label a subset for each factor (line items, summary fields, and model output). Then, weights are determined, referred to as “difficulty weights,” representing the difficulty of extracting data from the documents.

Next, a subset of the training set entities will be processed using a small model tasked with extracting the fields (using the same prompt that will be applied for the extraction task). Following this, annotators may review the extraction and classify the extraction as either successful (positive class) or unsuccessful (negative class).

The next training data generation step is to label the training and validation data sets. A logistic regression may be employed to ascertain the “difficulty weights,” which will then be used to generate labels for the training and validation datasets. The approach strategically balances automation with human validation in the labeling process.

Attention is now turned to training the routing model. Once the training data labels are obtained, as described above, a classifier (i.e., the routing model) is constructed to determine if a small language model is adequate to extract data from the input. In particular, in the extraction of document data, routing between small and large language models can be accomplished using metadata alone, in many cases. This method has several benefits over utilizing transformers on the unstructured data, particularly in terms of speed and cost-effectiveness. Metadata features like document type (which can be determined by the document type classifier's prediction) and confidence score may indicate that it is easy to extract information from documents that are of a certain type. Additionally, features such as document length and the number of numerical characters may be considered, with the former typically being easier to extract information from. However, documents with too many numerical characters can present difficulties in identifying which figures correspond to which line item. With such tabular features, a tree-based model (e.g., Xgboost) may be used for the routing task.

Next, embeddings from the document are incorporated. Although metadata can be useful for routing between language models, it may not always be sufficient. In cases where the model's confidence score falls around 0.5; e.g., between 0.4 and 0.6, indicating uncertainty in proper routing, a more sophisticated routing algorithm may be used that leverages direct document representation. For this purpose, a document understanding transformer (such as Donut) may be used. Additionally, tabular features may be processed through a series of dense layers. To handle these two inputs, both tabular and unstructured data, a sequence of common dense layers may be employed to integrate both data streams. Ultimately, a classification layer combines the outputs from these sources, enabling an accurate routing decision.

FIG. 3A and FIG. 3B together show an example of efficient automated data extraction by machine learning routing, in accordance with one or more embodiments. The following example is for explanatory purposes only and not intended to limit the scope of one or more embodiments. FIG. 3A and FIG. 3B should be considered together as a whole.

In the example, various data from a number of documents (300) are to be extracted. The documents (300) include both structured and unstructured data, screenshots and handwritten documents stored as images, as well as other types of documents.

Then, a metadata extractor (302) generates a metadata file for each of the documents (e.g., metadata file 1 (304) for document 1, metadata file N (306) for document N, etc.). Each metadata file includes metadata, such as a document type for the corresponding document, a number of pages for the corresponding document, and other metadata features. Each of the metadata files is a vector data structure.

Thus, the metadata files are provided as an input to a fast-routing model (308). In the example, the fast-routing model (308) is an XGBoost classification model. The fast-routing model (308) outputs an initial routing decision (310). The initial routing decision (310) is a decision to route a corresponding document to either a simple extraction model (312) or to a complex extraction model (314) to extract extracted data (316) from the document in question.

The fast-routing model (308) also outputs a confidence score (318). If the confidence score (318) satisfies a first predetermined threshold (e.g., is equal to or greater than the first predetermined threshold) then initial routing decision (310) controls whether the document in question is routed to the simple extraction model (312) or to the complex extraction model (314). The first predetermined threshold may be relatively high (compared to a second predetermined threshold, described below).

If the confidence score (318) fails to satisfy a second predetermined threshold (e.g., is less than the second predetermined threshold) then the fast-routing model (308) may automatically route the document in question to the complex extraction model (314). The complex extraction model (314) will then perform the data extraction.

In the example, an intermediate confidence range of numbers exist between the first predetermined threshold and the second predetermined threshold. If the confidence score (318) falls within the intermediate confidence range, then the metadata file corresponding to the document in question is provided to a complex routing model (320). The complex routing model (320) is referred to as “complex” because the complex routing model (320) is computationally more expensive to execute than the fast routing model (308), but the complex routing model (320) is more accurate or more capable than the fast routing model (308), or both more accurate and more capable than the fast routing model (308). The complex routing model (320) may be a document understanding transformer, such as Donut, and may include dense processing layers (322). Nevertheless, the complex routing model (320) is less computationally expensive to execute than the complex extraction model (314) and may be less computational expensive to execute than either the simple extraction model (312) or the complex extraction model (314).

In the example, the routing decision of the complex routing model (320) is final. Thus, if the routing decision of the complex routing model (320) is “simple,” then the document in question is routed to the simple extraction model (312) for data extraction. If the routing decision of the complex routing model (320) is “complex,” then the document in question is routed to the complex extraction model (314) for data extraction.

The simple extraction model (312) is computationally less expensive to execute than the complex extraction model (314). In the example, the simple extraction model (312) is an optical character recognition (OCR) program. For example, the OCR program may take a portable document file (PDF) or an image with simple characters and recognize characters from the file in question.

In the example, the complex extraction model (314) is a large language model. For example, the complex routing model (320) may be a multimodal language model capable of extracting the document data from combinations of images and text. A predetermined prompt is used to command the large language model to extract data from the document in question. For example, a document such as a complex image with tables in which data categories must be matched with data values present in the document will be sent to the complex extraction model (314) for data extraction.

Whichever extraction model performs the extraction (i.e., either the simple extraction model (312) or the complex extraction model (314)) the result is extracted data (316). The extracted data (316) is the desired data extracted from the documents (300). The extracted data (316) is stored for further automated analysis and processing or presented to a user on a graphical user interface.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 4A, the computing system (400) may include one or more computer processor(s) (402), non-persistent storage device(s) (404), persistent storage device(s) (406), a communication interface (408) (e.g., Bluetooth interface, infrared interface, network interface, optical interface, etc.), and numerous other elements and functionalities that implement the features and elements of the disclosure. The computer processor(s) (402) may be an integrated circuit for processing instructions. The computer processor(s) (402) may be one or more cores, or micro-cores, of a processor. The computer processor(s) (402) includes one or more processors. The computer processor(s) (402) may include a central processing unit (CPU), a graphics processing unit (GPU), a tensor processing unit (TPU), combinations thereof, etc.

The input device(s) (410) may include a touchscreen, keyboard, mouse, microphone, touchpad, electronic pen, or any other type of input device. The input device(s) (410) may receive inputs from a user that are responsive to data and messages presented by the output device(s) (412). The inputs may include text input, audio input, video input, etc., which may be processed and transmitted by the computing system (400) in accordance with one or more embodiments. The communication interface (408) may include an integrated circuit for connecting the computing system (400) to a network (not shown) (e.g., a local area network (LAN), a wide area network (WAN), such as the Internet, mobile network, or any other type of network) or to another device, such as another computing device, and combinations thereof.

Further, the output device(s) (412) may include a display device, a printer, external storage, or any other output device. One or more of the output device(s) (412) may be the same or different from the input device(s) (410). The input device(s) (410) and output device(s) (412) may be locally or remotely connected to the computer processor(s) (402). Many different types of computing systems exist, and the aforementioned input device(s) (410) and output device(s) (412) may take other forms. The output device(s) (412) may display data and messages that are transmitted and received by the computing system (400). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium, such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (402), is configured to perform one or more embodiments, which may include transmitting, receiving, presenting, and displaying data and messages described in the other figures of the disclosure.

The computing system (400) in FIG. 4A may be connected to, or be a part of, a network. For example, as shown in FIG. 4B, the network (420) may include multiple nodes (e.g., node X (422) and node Y (424), as well as extant intervening nodes between node X (422) and node Y (424)). Each node may correspond to a computing system, such as the computing system shown in FIG. 4A, or a group of nodes combined may correspond to the computing system shown in FIG. 4A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (400) may be located at a remote location and connected to the other elements over a network.

The nodes (e.g., node X (422) and node Y (424)) in the network (420) may be configured to provide services for a client device (426). The services may include receiving requests and transmitting responses to the client device (426). For example, the nodes may be part of a cloud computing system. The client device (426) may be a computing system, such as the computing system shown in FIG. 4A. Further, the client device (426) may include or perform all or a portion of one or more embodiments.

The computing system of FIG. 4A may include functionality to present data (including raw data, processed data, and combinations thereof), such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
receiving a document, comprising content data, for document extraction of the content data;
generating a metadata data structure storing metadata for the document;
executing a routing model on the metadata data structure to generate a complexity prediction and a corresponding confidence score for the complexity prediction, wherein the complexity prediction comprises an indication of an extraction complexity of performing the document extraction;
determining, based on a combination of the complexity prediction and the corresponding confidence score, a routing decision to route the document to one of a first extraction model comprising a low computational cost and a second extraction model comprising a high computational cost relative to the low computational cost; and
routing, according to the routing decision, the document to a selected model comprising the first extraction model or the second extraction model.

2. The method of claim 1, further comprising:
extracting, by the selected model, content data from the document; and
returning the content data.

3. The method of claim 1, wherein determining the routing decision comprises:
routing, responsive to the extraction complexity indicating a low complexity and the corresponding confidence score exceeding a first threshold, the document to the first extraction model.

4. The method of claim 1, wherein determining the routing decision comprises:
routing, responsive to the extraction complexity indicating a high complexity and the corresponding confidence score exceeding a first threshold, the document to the second extraction model.

5. The method of claim 1, wherein determining the routing decision comprises:
routing, responsive to corresponding confidence score failing to satisfy a second threshold lower than a first threshold, the document to the second extraction model without regard to the complexity prediction.

6. The method of claim 1, further comprising:
determining that the corresponding confidence score falls between a first threshold and a second threshold less than a first threshold; and
executing, responsive to determining the corresponding confidence score falls between the first threshold and the second threshold, a complex routing model on both the metadata data structure and at least some content of the document, wherein:
the complex routing model comprises a second computational cost higher than a first computational cost of the routing model, and
executing the complex routing model generates a second routing decision between the first extraction model and the second extraction model,
wherein determining the routing decision comprises routing the document one of the first extraction model and the second extraction model according to the second routing decision.

7. The method of claim 1, wherein generating the metadata data structure comprises:
determining a type of the document;
assigning a metadata value to the type of the document; and
storing the metadata value as the metadata.

8. The method of claim 7, wherein the type of the document comprises at least one of a file extension of the document and a classification of the document.

9. The method of claim 1, wherein generating the metadata data structure comprises:
determining a structure of the document;
assigning a metadata value to the structure of the document; and
storing the metadata value as the metadata.

10. The method of claim 9, wherein the structure of the document comprises at least one of a tabular structure, a table structure, and a text structure.

11. The method of claim 10, wherein the document comprises a tabular structure, and wherein routing comprises routing the document to a tree-based machine learning model.

12. A system comprising:
a computer processor;
a data repository in communication with the computer processor and storing:
a document comprising content data,
a metadata data structure storing metadata for the document,
a complexity prediction comprising an indication of an extraction complexity of performing a document extraction on the document,
a confidence score corresponding to the complexity prediction, and
a routing decision;
a first extraction model in communication with the computer processor and comprising a low computational cost;
a second extraction model in communication with the computer processor and comprising a high computational cost relative to the low computational cost;
a routing model which, when executed by the computer processor on the metadata data structure:
generates the complexity prediction and the confidence score; and
a server controller which, when executed by the computer processor:
receives the document,
generates the metadata data structure,
executes the routing model,
determines, based on a combination of the complexity prediction and the confidence score, the routing decision to route the document to one of the first extraction model and the second extraction model, and
routes, according to the routing decision, the document to a selected model comprising the first extraction model or the second extraction model.

13. The system of claim 12, wherein the server controller, when executed by the computer processor is further configured to:
extract, by the selected model, content data from the document; and
return the content data.

14. The system of claim 12, wherein determining the routing decision comprises routing, responsive to the extraction complexity indicating a low complexity and the confidence score exceeding a first threshold, the document to the first extraction model.

15. The system of claim 12, wherein determining the routing decision comprises routing, responsive to the extraction complexity indicating a high complexity and the confidence score exceeding a first threshold, the document to the second extraction model.

16. The system of claim 12, wherein determining the routing decision comprises routing, responsive to confidence score failing to satisfy a second threshold lower than a first threshold, the document to the second extraction model without regard to the complexity prediction.

17. The system of claim 12, wherein the server controller, when executed by the computer processor is further configured to:
determine that the confidence score falls between a first threshold and a second threshold less than the first threshold, and
execute, responsive to determining the confidence score falls between the first threshold and the second threshold, a complex routing model on both the metadata data structure and at least some content of the document, wherein:
the complex routing model comprises a second computational cost higher than a first computational cost of the routing model, and
executing the complex routing model generates a second routing decision between the first extraction model and the second extraction model,
wherein determining the routing decision comprises routing the document one of the first extraction model and the second extraction model according to the second routing decision.

18. The system of claim 12, wherein generating the metadata data structure comprises:
determining a type of the document,
assigning a first metadata value to the type of the document, and
determining a structure of the document,
assigning a second metadata value to the structure of the document, and
storing the first metadata value and the second metadata value as the metadata.

19. A method comprising:
receiving a document, comprising content data, for document extraction of the content data;
generating a metadata data structure storing metadata for the document;
executing a routing model on the metadata data structure to generate a complexity prediction and a corresponding confidence score for the complexity prediction, wherein the complexity prediction comprises an indication of an extraction complexity of performing the document extraction;
determining that the confidence score falls between a first threshold and a second threshold less than the first threshold;
executing, responsive to determining the confidence score falls between the first threshold and the second threshold, a complex routing model on both the metadata data structure and at least some content of the document, wherein:
the complex routing model comprises a second computational cost higher than a first computational cost of the routing model, and
executing the complex routing model generates a routing decision between a first extraction model comprising a low computational cost and a second extraction model comprising a high computational cost relative to the low computational cost; and
routing, according to the routing decision, the document to a selected model comprising the first extraction model or the second extraction model.

20. The method of claim 19, further comprising:
extracting, by the selected model, content data from the document; and
returning the content data.
